(19) United States
(12) Patent Application Publication
(10) Pub. No.: US 2003/0111799 A1
(43) Pub. Date: Jun. 19, 2003

(54) Seal for riser assembly telescoping joint

(75) Inventor: David L. Gilmore, Baytown, TX (US)

Correspondence Address: COOPER CAMERON CORPORATION, 13013 NORTHWEST FREEWAY, PO BOX 1212 (77251-1212), HOUSTON, TX, 77040, US

(73) Assignee: Cooper Cameron Corporation

(21) Appl. No.: 10/025,518

(22) Filed: Dec. 19, 2001

(51) Int. Cl. F16J 15/18

(52) U.S. Cl. 277/510

(57) ABSTRACT

A new seal system for a marine riser telescoping joint is revealed. The sealing face of the seal has tapered upper and/or lower tapered surfaces. The upper and/or lower ends can have a taper of about 1-15 degrees or alternatively the surrounding housing can have the taper with the seal ends either straight cut or tapered so that the combined tapers are in the stated range. The sealing elements are preferably nitrile or polyurethane and preferably without inserts. The upper and/or lower ends of the seal can have projections or depressions to aid in end sealing and eliminate the need for end seal rings. The new seals can be used individually or in stacks in a single housing.

### FIELD OF THE INVENTION

The field of the invention relates to telescoping joints used in offshore applications to connect surface equipment to a sub-sea wellhead.

### BACKGROUND OF THE INVENTION

When sub-sea wellheads need to be connected to a floating platform or a vessel a telescoping joint is employed to compensate for surface wave action. The telescoping joint typically is an assembly of an outer barrel around an inner barrel with the seal assembly in the annular space between. Pressure can be applied behind such seals to further encourage them into sealing contact with the inner barrel. Various resilient materials that can withstand the service have been used including nitrile rubber. The American Petroleum Institute (API) has established pressure ratings for such seals in its specification 16F, which calls for testing to 200 PSI.

However, when higher operating pressures were desired, known seals for telescoping joints were not capable of reliable operation and the present invention involves a variety of designs, which have allowed working pressures of 750 PSI with reliable operation. The new configurations and new materials used for these seals are capable of performing reliably at higher pressures without undue wear or significant issues of leakage.

The complexity of known seals is more readily seen by Referring to FIG. 1, which juxtaposes a known seal design K against an embodiment of the present invention. Referring to FIG. 1, the known seal assembly K comprises an annularly shaped seal 10 made of nitrile rubber having an embedded upper stiffener ring 12 and a lower stiffener ring 14. A backup ring 16 has perforations 18. Perforations 18 allow pressurized air from inlet 20 to push the seal 10, and more particularly sealing face 22 against the inner barrel 24. Outlet 26 allows release of pressure from chamber 28 using an external control system (not shown) which modulates pressure in chamber 28 to be slightly above the pressure between the housing 30, which is connected to the outer barrel (not shown) and the inner barrel 24. As shown in FIG. 1, housing 30 has a lower body 32 to which are mounted an upper compression ring 34 and a lower compression ring 36. At the upper end 38 of lower compression ring 36 a seal ring 40 is mounted for contact with seal 10. Similarly, upper compression ring 34, which has several components, also comprises a seal ring 42 for contact with seal 10. Cap screws 44 hold the mating surfaces of the lower compression ring 36 and body 32 together. Tightening nut 48 to stud 46 brings the upper compression ring 34 down on seal 10 to put it into longitudinal compression, for sealing at its ends using seal rings 40 and 42. Wear bands 50 and 52 respectively protect the upper compression ring 34 and the lower compression ring 36 from wear due to stroking movement of the inner barrel 24. The housing 30 has a connector 54 for mounting of a second seal, in FIG. 1 the second seal 56 is, in fact, one of the embodiments of the present invention. A second or third or more seals are frequently known to be assembled in to a housing such as 30 so that if a first seal such as 10 has a failure, operation may continue without downtime as pressure is provided behind another seal to energize it into contact with the inner barrel 24. The use of multiple seals is intended to be a part of the invention, particularly when incorporating the seal assembly 56, as is the seal assembly itself and how an individual assembly interacts with the surrounding housing as well as the housing configuration itself. FIG. 1 presents a convenient way to juxtapose the old seal design against one embodiment of the present inventive seal design. Those skilled in the art will appreciate that the known design for the seal 10 is difficult and costly to manufacture. It has operational pressure limits in the order of about 200-500 PSI for continuous reliable operation. It requires careful placement of the end seal rings 40 and 42 and the stiffening effect from the backing ring 16 working in conjunction with the upper stiffening ring 12 and lower stiffening ring 14. The advantages of the various embodiments of the present invention will be readily appreciated by those skilled in the art from a review of the description of the preferred embodiment, which appears below.

### SUMMARY OF THE INVENTION

A new seal system for a marine riser telescoping joint is revealed. The sealing face of the seal has tapered upper and/or lower tapered surfaces. The upper and/or lower ends can have a taper of about 1-15 degrees or alternatively the surrounding housing can have the taper with the seal ends either straight cut or tapered so that the combined tapers are in the stated range. The sealing elements are preferably nitrile or polyurethane and preferably without inserts. The upper and/or lower ends of the seal can have projections or depressions to aid in end sealing and eliminate the need for end seal rings. The new seals can be used individually or in stacks in a single housing or in multiple housings.

### BRIEF DESCRIPTION OF THE DRAWINGS

FIG. 1 is a sectional elevation view of a telescoping joint seal assembly showing an old seal 10 juxtaposed with an embodiment of a new seal 56;

FIG. 2 shows a tandem arrangement of one of the seal designs of the present invention;

FIG. 3 is an alternative mounting to FIG. 2;

FIG. 4 illustrates the taper feature in the surrounding housing at the upper and lower ends of the seal;

FIG. 5 is a tandem arrangement showing the end protrusions;

FIG. 6 is the view of FIG. 5 showing a stack of three seals;

FIG. 7 is a tandem arrangement showing a protrusion on one end and a flat opposite end;

FIG. 8 is a tandem arrangement showing a protrusion on one end of the seal abutting a flat on the housing and a tapered surface on the housing or the seal on the opposed end;

FIGS. 9-14 show alternative configurations of the seal in section view.

### DETAILED DESCRIPTION OF THE PREFERRED EMBODIMENT

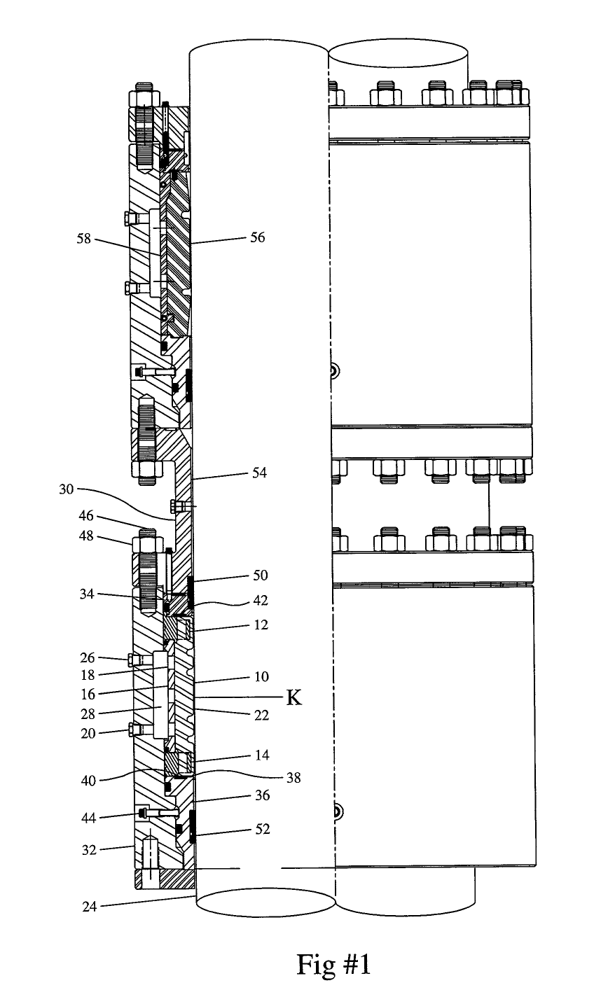

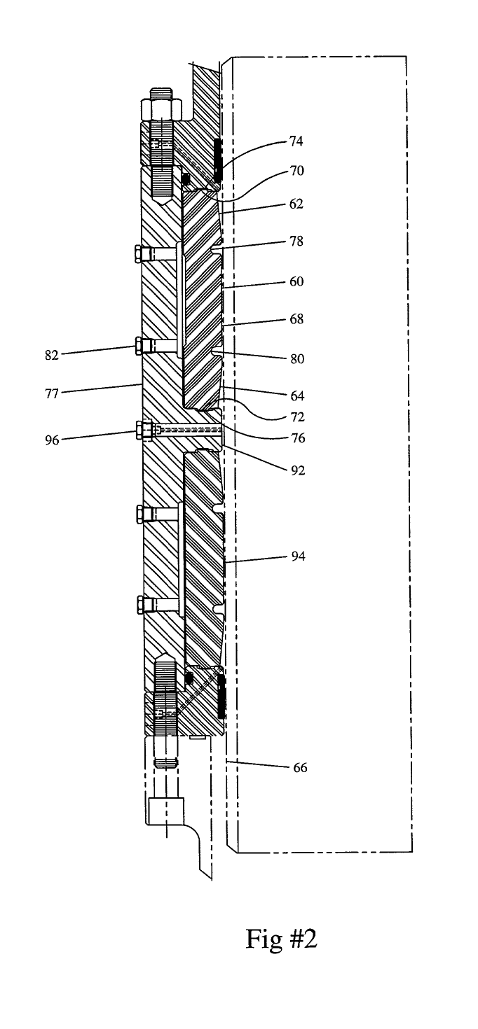

FIG. 1 is also illustrative of one of the embodiments of the present invention. Seal 56 can be optionally used with a backup ring 58. In FIG. 2 the seal 60 is used without such a backup ring. As better seen in FIG. 2, the seal 60 has surfaces 62 and 64, which face the inner barrel 66 (shown schematically and removed in the seal area for clarity) and are disposed above and below surface 68. Projections 70 and 72 are respectively at the upper and lower ends of the seal 60. They respectively extend into depressions 74 and 76 in the housing 77. This arrangement is reversible so that the protrusions are on the housing 77 while the depressions are on the seal 60. Grooves 78 and 80 are used to retain grease to reduce the wear of surface 68 by movements of the inner barrel 66. Seal 60 is energized to seal against inner barrel 66 by applying air pressure at inlet 82, in a known manner. The protrusions 70 and 72 are compressed toward each other by the depressions 74 and 76 to enhance end sealing. This longitudinal compression and the interlocking nature of the end contact between the seal 60 and the housing 77 replaces the more complex system of the prior seal 10, which used separate seal rings 40 and 42. The taper angle of surfaces 62 and 64 allows a greater degree of flexing of the seal 60, particularly when activated by air pressure at inlet 82. When used in tandem, only one seal is activated into contact with the inner barrel 66 after pressure is applied to its respective inlet 82. The flexing provided by the taper of about 1-15 degrees on surfaces 62 and 64, allows surface 68 to make better sealing contact with the inner barrel 66. The preferred material is a polyurethane of a durometer reading of 70A made from a TDI polyether, with ultimate tensile strength of about 1300 PSI, elongation above 600%, rebound greater than 58% and a compression set of about 25%.

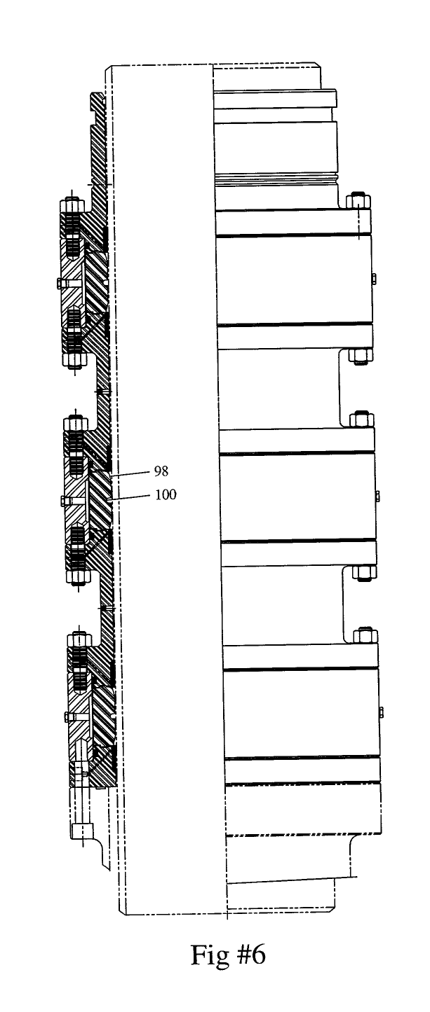

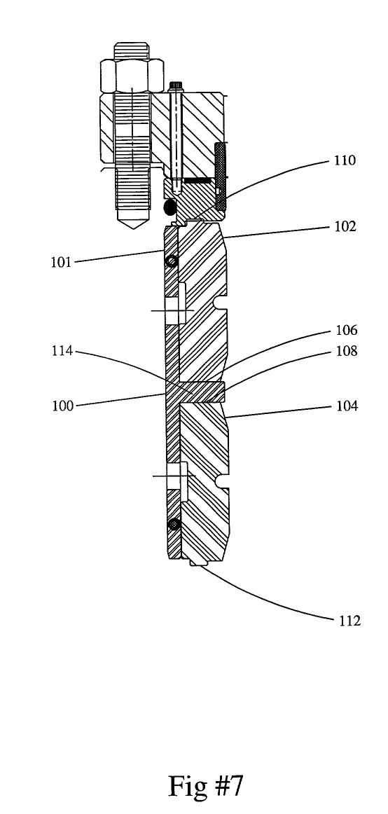

FIGS. 9 and 11 illustrate protrusions 84 and 86, which are respectively U or V shaped. These shapes can be identical at both ends, as shown, or they can be combined so one is at one end and the other is at the opposite end. Other protrusion shapes are contemplated such as rounded, oval, or elliptical to mention a few. The angles at the corners of the protrusions, if present, can be 90 degrees or greater, preferably. Included angles of less than 90 degrees can be used, giving the protrusions 84 and 86 the appearance of having an undercut when viewed in end section. FIGS. 10 and 12 illustrate the mirror image end treatment as compared with FIGS. 9 and 11. If depressions 88 and 90 were used, the adjacent housing would, of course, have the mating projections. The same variability previously described in conjunction with protrusions 84 and 86 are applicable in mirror image to depressions 88 and 90.

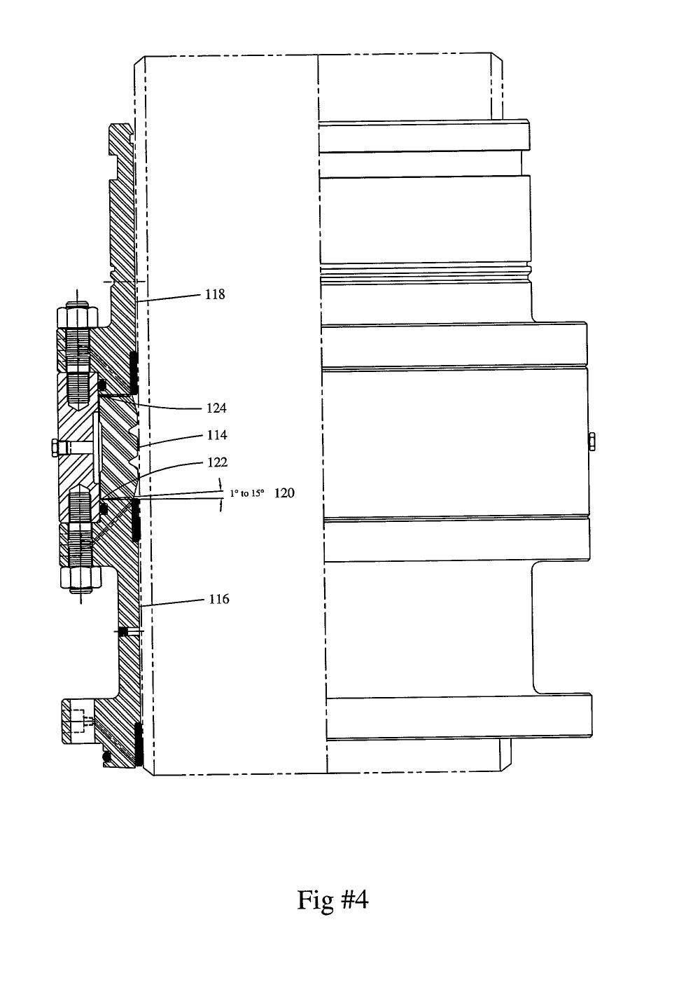

FIG. 2 illustrates a circular rib 92 to separate seals 60 and 94. A passage 96 can be used to detect leakage of seal 94 before seal 60 is energized into sealing surface by adding pressure at inlet 82. It should be noted that depressions 74 and 76 are somewhat wider than the projections 70 and 72 that extend into them. This feature allows seal 60 to be easily inserted and centered and promotes flexing under air pressure supplied to inlet 82, when it is desired to energize surface 68 into contact with the inner barrel 66. FIG. 3 is similar to FIG. 2 insofar as the seal design with the main difference being the use of a longer housing spacer ring 96 between the two seals 60 and 94. Note also the use of lubrication ports such as 97 to lubricate seal 94 and associated wear bands such as 99. FIGS. 5 and 6 are similar to FIG. 3 except the seals 98 are shorter and have a single grease groove 100. FIG. 5 illustrates the use of tandem seals while FIG. 6 uses a stack of three for additional backup capability.

FIG. 7 illustrates another variation involving the optional backup ring 101 used with tandem seals 102 and 104, where each seal has a flat end (106 and 108) and a protrusion (110 and 112) at the opposite end. A circular rib 114 separates the two seals 102 and 104 at the respective flat ends 106 and 108. The protrusions 106 and 108 could alternatively be depressions mating with protrusions on the adjacent housing. Alternatively, protrusions could be used at both ends of each seal 102 and 104, or depressions. The flat ends could be used instead of protrusions 110 and 112, although if this is done it is preferred that the adjacent housing have a slope to encourage compression of the seal end in a manner described below, to encourage the ends to seal more positively.

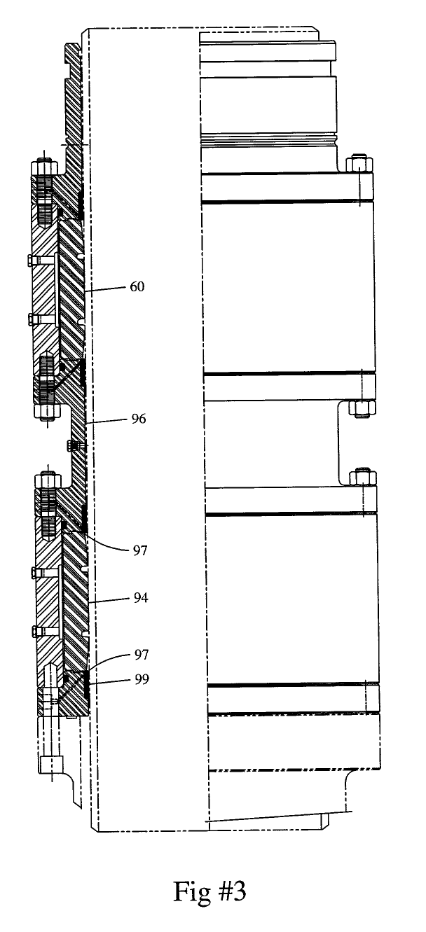

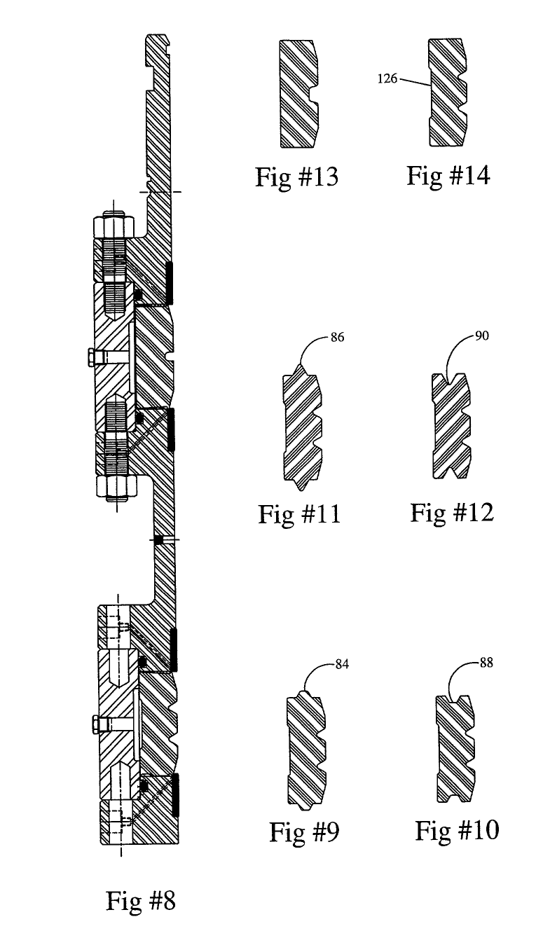

Another feature of the present invention is the angular end compression of a seal, such as 114 in FIG. 4, in one of several ways. The housing components 116 and 118 can have sloping surfaces which contact the ends of seal 114 so as to compress it upon installation in a range or about 1-15 degrees, as shown schematically by angle 120. Instead of slanting the housing surface, which is somewhat difficult to manufacture, the same result can be obtained by flaring out the ends of the seal 114 by making angles 122 and 124 in the range of about 91-105 degrees and the mating housing surface perpendicular to the longitudinal axis of the telescoping joint. FIGS. 13 and 14 illustrate seals that can be used in FIG. 4 when the housing mating surfaces are slanted and angles 122 and 124 are at about 90 degrees. Of course, a combination of sloping housing surfaces can be used in contact with sloping ends on the seal 114 if the net result is an angular compression of the ends of seal 114 in the range of about 1-15 degrees. For example the housing surface can be at 95 degrees from the longitudinal axis while angles 122 and 124 can also be 95 degrees to give a net angular compaction of each end of seal 114 of 10 degrees. Other combinations, within or outside of the preferred angular compaction range are also within the scope of the invention.

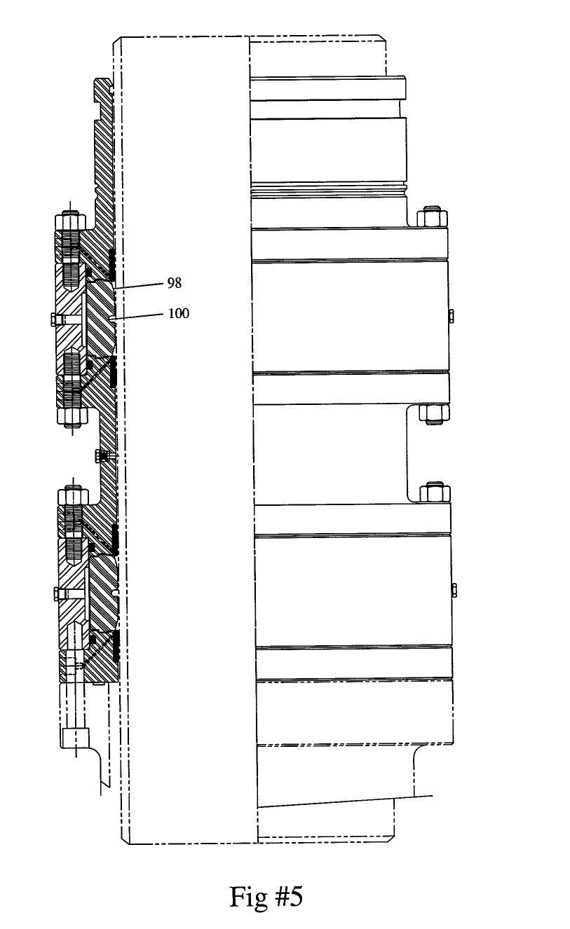

Just as the backup ring 101 is optional so is the relief 126 shown in FIG. 14 but absent in FIG. 13. The grease groves can be U or V shaped or both shapes can be used in the same seal. FIG. 8 illustrates the use of the seal of FIG. 14 in a tandem arrangement.

Those skilled in the art will appreciate that the angular compression can serve as an alternate way of end sealing to the protrusion depression technique, previously described. Alternatively they could also be combined to get the additive effect of both techniques. The end treatments can be identical or they can be different using a mix and match technique with the disclosed ways of end sealing. The angular compression of the seal further promoted the subsequent contact with the inner barrel 66 when a given seal is energized into contact by applied air pressure.

The above description is illustrative of the preferred embodiment and many modifications made be made by those skilled in the art without departing from the invention whose scope is to be determined from the literal and equivalent scope of the claims below:

I claim:

1. A seal assembly for a telescoping joint, comprising:
a first and second nested tubular members slidably mounted with respect to each other and defining an annular space therebetween;
at least one seal, supported by one of said tubular members and sealingly spanning said annular space, said seal having a longitudinal axis and opposed ends and being compressed, upon assembly to said tubular member retaining it, in a direction substantially aligned with its longitudinal axis.

2. The assembly of claim 1, wherein:
said compression of said seal is due to an interference fit in said tubular member that retains it.

3. The assembly of claim 2, wherein:
said interference fit is created by forming opposed seal ends, prior to mounting, being disposed in non-parallel planes while said tubular member which retains said seal comprises retaining surfaces that are disposed in parallel planes.

4. The assembly of claim 2, wherein:
said interference fit is created by forming opposed seal ends, prior to mounting, being disposed in parallel planes while said tubular member which retains said seal comprises retaining surfaces that are disposed in non-parallel planes.

5. The assembly of claim 2, wherein: said interference fit is formed by having at least one seal end, prior to mounting, in a different plane than a surface on said tubular member against which it is to abut, upon mounting.

6. The assembly of claim 2, wherein:
said seal further comprises a sealing surface having an upper and a lower end and where at least one of said ends is beveled with respect to said longitudinal axis.

7. The assembly of claim 6, wherein:
said bevel ranges from greater than 0 degrees from said longitudinal axis to at least about 15 degrees.

8. The assembly of claim 2, wherein:
said seal is retained to said tubular member on at least one end by a projection-depression configuration between an end of said seal and an adjacent tubular member retaining it.

9. The assembly of claim 8, wherein:
said depression is longer than said projection in a direction perpendicular to the longitudinal axis of said seal.

10. The assembly of claim 9, wherein:
said projection comprises a U or V shape or forms an undercut with respect to said depression.

11. The assembly of claim 2, wherein:
said tubular member that retains said seal further comprises a passage to allow a lubricant to be directed from outside said annular space to a sealing face on said seal in said annular space.

12. A seal assembly for a telescoping joint, comprising:
a first and second nested tubular members slidably mounted with respect to each other and defining an annular space therebetween;
at least one seal, supported by one of said tubular members and sealingly spanning said annular space, said seal having a longitudinal axis and opposed ends and said seal is retained to said tubular member on at least one end by a projection-depression configuration between an end of said seal and an adjacent tubular member retaining it.

13. The assembly of claim 12, wherein:
said seal further comprises a sealing surface having an upper and a lower end and where at least one of said ends is beveled with respect to said longitudinal axis.

14. The assembly of claim 13, wherein:
said seal is compressed, upon assembly to said tubular member retaining it, in a direction substantially aligned with its longitudinal axis.

15. A seal assembly for a telescoping joint, comprising:
a first and second nested tubular members slidably mounted with respect to each other and defining an annular space therebetween;
at least one seal, supported by one of said tubular members and sealingly spanning said annular space, said seal having a longitudinal axis and opposed ends and said seal further comprises a sealing surface having an upper and a lower end and where at least one of said ends is beveled with respect to said longitudinal axis.

16. The assembly of claim 15, wherein:
said seal is retained to said tubular member on at least one end by a projection-depression configuration between an end of said seal and an adjacent tubular member retaining it.

17. The assembly of claim 16, wherein:
said seal is compressed, upon assembly to said tubular member retaining it, in a direction substantially aligned with its longitudinal axis, said compression of said seal is due to an interference fit in said tubular member that retains it.

18. The assembly of claim 17, wherein:
said interference fit is formed by having at least one seal end, prior to mounting, in a different plane than a surface on said tubular member against which it is to abut, upon mounting.

19. The assembly of claim 1, wherein:
said seal is formed of nitrile or polyurethane.

20. The assembly of claim 12, wherein:
said seal is formed of nitrile or polyurethane.
